(19) United States
(12) Patent Application Publication
(10) Pub. No.: US 2014/0371875 A1
(43) Pub. Date: Dec. 18, 2014

(54) SYSTEM AND METHOD FOR CONTROLLING JOINT ACCESS TO AN APPARATUS

(71) Applicant: TECBAK, Paris (FR)

(72) Inventors: Jerome BOYE, PARIS (FR); Regis WEILL, MILANO (IT); Lucas FERNANDEZ, PARIS (FR); Yvan FREDRIC, BIERNE (FR)

(73) Assignee: TECBAK, Paris (FR)

(21) Appl. No.: 13/916,453

(22) Filed: Jun. 12, 2013

(51) Int. Cl. G05B 15/02

(52) U.S. Cl. CPC G05B 15/02
USPC 700/9

(57) ABSTRACT

The invention proposes a system comprising:
a plurality of pieces of equipment, each of them being able to receive a group of participants, each piece of equipment defining a position for a participant and each piece of equipment being provided with a digital processing unit,
a central server,
network communications means between the central server and the plurality of pieces of equipment,
a plurality of participants' terminals capable of network communications with the central server and of interacting with the processing unit of the piece of equipment,
means for managing sessions on the piece of equipment, implemented by cooperation between the central server and the processing units of the pieces of equipment via the communications means, and
control and identification means implemented by cooperation between the central server, the processing units of the pieces of equipment and the terminals and allowing, on the one hand, the access to sessions on the equipment by a group of participants and their identification and, on the other hand, an allocation of each identified participant to a position at the piece of equipment.

Application in particular to game equipment such as football tables.

### FIELD OF THE INVENTION

This invention relates to a system and a method for controlling joint access by a plurality of participants to common pieces of equipment, each piece of equipment being provided with a set of positions or posts, and for managing such pieces of equipment.

### BACKGROUND OF THE INVENTION

Physical access control systems are used in daily life: a mechanical gate opened upon insertion of a metro ticket or on presentation of a badge equipped with a RFID chip, contractual authorization of access to a train or to a bus by ticket stamping, table football or electronic game with coin acceptor.

Some of the approaches among the most recent will be mentioned below.

NFC Electronic Key

Near Field Communication (NFC) technologies that allow completing a mutual authentication of a terminal and an electronic socket are nowadays integrated into smartphones. This allows using a smartphone as an electronic key, for example to gain access to a campus: The Arizona State University® students gain access to their residence hall and selected rooms by presenting the phones to their door readers.

NFC Electronic Ticket

When this system is associated with temporary rights, it allows an access as e-ticket, for example:
Japan Airlines® uses mobile tools for automated entry with integrated Circuit boarding passes, in security areas and at boarding gates. The process is simple as the passenger touching their mobile phone to a scanner that reads the NFC signal.
Blue Label Telecoms® uses a paperless ticketing system that allows supporters to purchase their tickets on their mobile phones or from the Web site, and tap their NFC cards to gain access to the stadium.

Electronic Key Via QR-Code

In some cases, NFC technology is not adapted when the user is not equipped with a NFC terminal or when it would be costly to integrate a NFC electronic socket at the accessed service. An optical code, for example a QR-code, is then appropriate. In particular:
Virgin America's® travelers can reserve a Silvercar™ via the Silvercar App™. Upon arrival at the destination airport, they scan a QR-code located on the windshield of the Silvercar™ to unlock the vehicle—and drive to their final destination.
Amadeus (US20130059603) discloses an access system to a hotel room by scanning a QR-code printed on the door.

Electronic Ticket Via QR-Code

Eventbrite® allows issuing electronic tickets printable on paper comprising a Q-code. The user presents this ticket to a hostess at the reception desk of an event, who scans the QR-code with her smartphone.

NCR Corporation® (EP2587421) discloses an airport boarding gate that can be opened by presentation of a QR-code displayed on the screen of the user's smartphone.

As alternatives:
When the cell phones of the users are not equipped with QR-code display means, a text reader can be integrated into the electronic socket: Having recognized that just 35% of Australians possess a smartphone the airline company Jestar® developed the SMS boarding pass and reader, which allows phones that do not display QR-codes or graphics to perform automated entry with a unique text code.
Depending on the selected safety level, the access control process may require additional steps, for example the entry of a code on the electronic socket: As an example, Diebold® preregistered bank customers scan the ATM's QR-code using their smartphones. When the devices sync, a transaction screen appears on the smartphone and then the user selects a withdrawal amount. A one-time code then is sent to the smartphone, which the customer enters on the ATM screen to authenticate the transaction and receives cash.

The choice of an access system thus defines the type of access (key, ticket), the type of required hardware (NFC smartphone, QR-code printed or displayed) and a certain safety level.

Additional Services Authorized by the Selected Access Control

This choice is also decisive for the additional services that can be associated therewith:
ScootNetworks® is a service of shared scooters, accessible with a smartphone as an electronic key. These scooters are equipped with a dock to maintain the user's smartphone on the tiller. By means of the geolocation means integrated into this smartphone, the operator is informed of the location of each scooter. The operator can thus offer to the users the choice of the location where to drop off the scooter, which is not necessarily that where it has been picked up.
ShareKey® allows for any smartphone to be granted access to the doors for a specified amount of time, be it a few hours or a few weeks. This can be useful for house guests, dog walkers or plant waterers. The system can send these “electronic keys” directly to the recipient's smartphone as a QR-code via email.
Eventbrite® allows an organizer to define an event, to issue invitations by electronic mail, to sell tickets on-line, to report statistics or to check the subscribers list.
Xerox Corporation® (EP2444924) discloses an access system to parking spaces, a car presence sensor being integrated in each of them. The user makes the reservation of a parking space with his smartphone. He can thus see the free spaces nearby, those that will soon be available and reserve a particular space or a space nearby.

However, none of these systems allows a simultaneous access with an individualized and controlled use to several users of a same service on a piece of equipment:
In the case of an electronic ticket, for example, the access gate opens when the ticket is recognized but it does not control if the user occupies the reserved seat (train, airplane) or goes to the reserved seating area (stadium). The individual character of the use of the service is thus not controlled at the time of delivery of this service. The later checking by a train controller, a stewardess or a control agent is thus still necessary. But it might be interesting to make sure that a passenger occupies the right seat and to tell him/her his/her error, as the case may be.
According to another example, a game or sports tournament, for example a table football or table soccer tournament, requires a complex organization in view of the number of referees to be involved. For a game to be homologated, a particular requirement is that the referee must be able to check the identity and the position occupied by the four players. It might be interesting to automatically control the position of the players to assist the competition refereeing and even to replace it by electronic refereeing.

### SUMMARY OF THE INVENTION

Consequently, one object of the invention is to propose a solution for controlling the joint access to a piece of equipment with an individualized use. An additional object is to grant a use depending on this control. An auxiliary object is to grant additional services made possible by this access control solution.

To this end, according to a first aspect of the invention, a system is proposed that comprises:
a plurality of pieces of equipment, each of them being able to receive a group of participants, each piece of equipment defining a position or a post for a participant and each piece of equipment being provided with a digital processing unit,
a central server,
network communications means between the central server and the plurality of pieces of equipment,
a plurality of participants' terminals capable of network communications with the central server and of interacting with the processing unit of the piece of equipment,
means for managing sessions on the piece of equipment implemented in cooperation between the central server and the processing units of the pieces of equipment via the communications means, and
control and identification means implemented by cooperation between the central server, the processing units of the pieces of equipment and the terminals and allowing, on the one hand, the access to sessions on the equipment by a group of participants and their identification and, on the other hand, an allocation of each identified participant to a position or post in the equipment.

Some preferred but non-restrictive aspects of this system comprise the following features, taken individually and in any technically compatible combinations:
the control and identification means comprise means for reading a position(s) code at the equipment among a set of such codes by a participant's terminal, means for communicating from said terminal to the central server a participant's identifier and information representative of the read code.
the position codes at the piece of equipment are selected among optical codes and codes readable by near-field communications interrogation.
the position codes at the piece of equipment also encode an identifier of a piece of equipment or of a group of pieces of equipment.
the control and identification means further comprise means for enabling a functionality of the piece of equipment from the central server when conditions required for the participants and the pieces of equipment and/or their positions have been determined as being fulfilled by the central server.
each piece of equipment is identified by the central server by means of a unique identifier associated with the piece of equipment.
each piece of equipment is identified by the central server by means of an identifier combined with a geolocation information of the piece of equipment.
the geolocation information is obtained from a user's terminal communicating with the central server.
the system further comprises means provided in a participant's terminal and/or at the processing unit of a piece of equipment for modifying, via a communication with the central server, associations between participants and positions stored in said central server.
a required condition is a required number of participants.
a required condition is an association between each position at the equipment and an identified participant.
the piece of equipment is a physical game apparatus.
the physical game apparatus comprises a set of sensors for providing information relating to the progress of the game to the central server via the communications means.
the physical game apparatus comprises devices capable of being controlled from the central server.

According to a second aspect, a method is proposed for managing the use of a piece of equipment by participants, wherein the piece of equipment is capable of implementing sessions involving a group of participants and defines for each participant a position, and wherein the piece of equipment is provided with a digital processing unit and with a set of wireless-readable codes that identify positions at the equipment, the method comprising the following steps:
reading, by terminals associated with a group of participants, a set of wireless-readable codes provided at a same piece of equipment,
transmitting to a central server requests for participation for the considered piece of equipment, said requests containing information representative of the read codes and of the identifiers of the respective participants,
verification at the central server of conditions required for the participants and the position codes,
in case the conditions are fulfilled, transmitting by the central server to the processing unit of the piece of equipment session authorization information,
processing said session authorization information at the processing unit to start a session at the piece of equipment.

In another implementation, a method is proposed for managing the use of a piece of equipment by participants, wherein the equipment is capable of implementing sessions involving a group of participants and defines a position for each participant and wherein the equipment is provided with a digital processing unit and with a device for reading wireless-readable codes capable of identifying participants to sessions at the equipment, the method comprising the following steps:
reading by the reader of a set of wireless-readable codes associated with a plurality of participants,
transmitting requests for participation for the considered piece of equipment to a central server, said requests containing information representative of the read codes and of positions at the equipment,
verification at the central server of conditions required for the participants and the position codes,
in case the conditions are fulfilled, transmitting by the central server to the processing unit of the piece of equipment session authorization information,
processing said session authorization information at the processing unit to start a session at the piece of equipment.

Moreover, an intelligent terminal is proposed for the participation of participants to sessions at a piece of equipment for the implementation of the first above-mentioned method, comprising:
means for wireless reading of a position code at a piece of equipment,
network communications means for communicating to a central server for equipment management information representative of the position code and a participant's identifier.

An intelligent terminal is also proposed or the participation of participants to sessions at a piece of equipment for the implementation of the second above-mentioned method, comprising:
means for selectively displaying a wireless-readable code identifying a participant owning the terminal

Advantageously, such a terminal further comprises means for communicating with a processing unit of a piece of equipment so that said processing unit can communicate with the central server via the terminal communicating means.

Finally, the invention proposes a software package capable of being executed on a communicating terminal in order to obtain a terminal as defined above.

### BRIEF DESCRIPTION OF THE DRAWINGS

Other features, aims and advantages of this invention will become apparent from the following detailed description, made with reference to the appended drawings provided as non-limiting examples and in which:

FIG. 1 illustrates a computer system adapted for the implementation of this invention;

FIG. 2 illustrates the main steps of the method for simultaneous access control with individualized use;

FIG. 3 illustrates the steps of the individualization method when the mobile terminal of only one of the four players has captured and decoded a QR-code, and

FIG. 4 illustrates an example of an instrumented table football apparatus that can be used within the scope of this invention.

### DETAILED DESCRIPTION OF PREFERRED EMBODIMENTS

A simultaneous access control with individualized use applied to a playing session (game) of instrumented table football will now be described. A real table football apparatus is thus equipped with electronic sensors such as infrared beams placed in goal cages that allow, for example, recording the game score. By means of data processing means with which the apparatus is equipped and which are connected to the internet, this score can be recorded at a web server and made available to the participants (players) within the scope of the organization of a tournament.

To go further and to allow an electronic refereeing level that can be accepted by the table football federations, not only the identification of each of the four players is provided but also the control of the position allocated to each of them.

The invention thus includes a simultaneous access control system with individualized use as described hereunder.

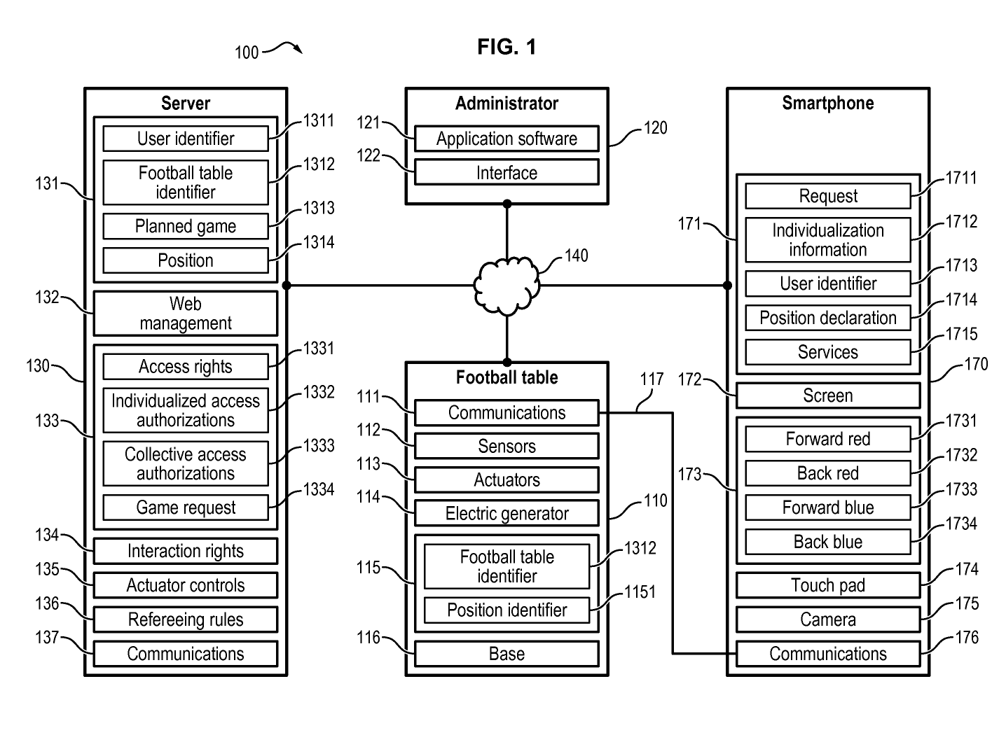

Referring to FIG. 1, a computer system 100 comprises services 110 implemented in a physical apparatus constituted here by the table football apparatus, administrator terminals 120, a server 130, user terminals 170, all of them linked by a communications network 140.

### Electronic Football Table 110

In this embodiment, a service 110 is implemented in a table football game apparatus equipped with a communications module 111, sensors 112, elements that can be controlled (or actuators) 113, electric generators 114, representations of identifiers 115 and bases 116.

A communications module 111 is a computer subsystem of the apparatus that can transfer the values measured by the sensors 112 to the server 130 via the network 140 and transmit display or control information coming from server 130 to the actuators 113 via network 140. As an alternative, a wired, Wi-Fi or Bluetooth connection 117 enables the communications module 111 to establish a communication with network 140 by means of the communications module 176 of a user terminal 170.

The sensors 112 allow measuring the table football game parameters. The list of these sensors comprises in particular all or part of the following elements:
an optical beam, in particular an infrared beam, in the goal cages,
an optical beam, in particular an infrared beam, in the ball retrieval channel 118,
a shock sensor at the back of the goal cage and on each playing figure (“foos man”) 119 of the apparatus,
an tilt sensor to sense when the apparatus is lifted,
a sensor for detecting the lifting of the playing rods, to which the playing figures are mounted,
an action sensor on the ball launching pull tab,
a skycam-type camera in an elevated position allowing filming the game, the players' hands and the players themselves,
a camera placed in the goal cage allowing filming the decisive shots,
a microphone allowing recording the players' voice or their messages to spectators users,
a camera and video camera 175, as well as a microphone—not shown—, for example that of a smartphone 170, possibly fixed on the base 116, used as sensors 112 via the communications modules 176 and 111,
a wattmeter for measuring the power produced by an electric generator 114,
a biometric sensor such as a capacitive sensor placed on the game handles for measuring the contact of the players' hands on the rods, the pressure exerted by the hands, the player's stress level by electrical conductivity and the player's heart rate,
a capacitive pad for measuring the spatial position of each playing figure as well as that of the ball. This allows the determination during the shoot of the position of the player figure with respect to the ball as well as to virtually reconstitute the game in its entirety.

As an alternative, the position of the ball can be measured by means of the combination of a RFID chip integrated into the ball and of a set of sensors able to measure the distance between the ball and them, for example of six distance sensors situated in the four corners of the pitch and half the distance between the longer sides of the pitch.

The actuators 113 allow converting information into displays for the players or into animation of the mechanisms of the table football apparatus. This information relates to:
the game in progress (scoring, trophies),
the referreeing (report of a spin move, of a fall, of a decision of the referee that differs from that of the electronic refereeing),
the operation of the football table (serving of a ball, access control error, stuck ball),
the animation of the game (music, light animation, video animation, mechanical vibrations),
the participation of the spectators users (tweets, animations, acoustic messages, photos),
the participation of the sponsors users (advertising).

The list of these actuators 113 comprises in particular all or part of the following elements:
A LED display for displaying the score and messages,
a computer screen,
a laser scanning display,
a LED placed on a player figure and turning on when contacting the ball,
a LED placed on the goal and changing color depending on the validity of the goal,
a LED lighting the tabletop during the game,
a projector for displaying animations on the inner walls of the table football apparatus,
a loudspeaker for broadcasting music, applause, sports comments, refereeing messages, messages from on-line spectators,
a vibrator for vibrating a handle of the football table,
a camera positioning motor for modifying the view angle of the camera,
a motor-driven basket for serving the balls,
a force feedback controller of a generator 114,
a flexible screen placed on the chest of a player figure for personalizing its appearance,
the screen 172 and the loudspeaker, not shown, of a smartphone 170, possibly fixed on a base 116, used as actuators 113 via the communications modules 111 et 176.

The electric generators 114 allow recovering part of the mechanical energy produced by the players onto the rods of the football table and by the shock of the ball onto the playing figures. These electric generators 114 feed the elements of the table football apparatus such as the communications module 111, the sensors 112 and the actuators 113 with electricity. These generators 114 are dynamos with rotational or translational motion or piezoelectric generators. They are controlled, i.e. the force feedback for the player is adjustable by an actuator controlled by the actuator control module 135. Moreover, the generators 114 recharge a battery—not shown—allowing the table football apparatus to have an energy reserve when the users are not playing.

### QR-codes 115

The identifier representations 115 are preferably two or four QR-codes that are distributed on both sides or at the four corners of the football table. Each QR-code encodes both a table football identifier 1312 and a position identifier 1151. If there are two QR-codes, a position identifier 1151 may take two values, for example values associated with the blue or red color traditionally representing the two teams on a commonly available table football apparatus. If there are four QR-codes, a position identifier 1151 may take four values, namely values associated with the positions red forward, red back, blue forward and blue back.

The bases 116 are constituted by a group of physical supports provided on the table football apparatus (preferably four bases) allowing the users to place and, if need be, to recharge their smartphone. These supports are placed next to the goal cages and each allow retaining a respective smartphone by means of a suitable mechanical system (clipping-on, clamping, insertion).

The administrator terminal 120 is a computer system, for example based on the architecture of a PC, a smartphone or a tablet, provided with a browser such as Chrome® or Explorer®. Furthermore, this terminal 120 is equipped with communications means adapted to connect to a computer server 130 via a network 140. Application software 121 executed by means of the browser allows the administrator to fully manage the computer system 100.

This administrator thus defines by means of a man/machine interface of the terminal:
the organization of the database of module 131,
the import of external data by module 131 from other servers 150, not shown, connected to the network 140. These data are relational links coming from social networks such as Facebook® or Twitter®, or players' ratings coming from servers 160, not shown, of table football federations,
the web pages of module 132,
the rules for controlling access to the football tables of module 133,
the rights of the users of module 134,
the actuator control rules of module 135,
the refereeing rules of module 136 such as the penalties or the calculation mode of the players' ratings.

The computer server 130 contains software applications among which a database module 131, a website management module 132, a module for managing access controls to the football tables 133, a module for management the users' rights 134, an actuator management module 135, an refereeing module 136 and a communications module 137.

### Database 131

The database module 131 contains a database relating to the users, the teams, the subscriptions, the football tables, the games, the tournaments, the challenges and the advertisements. The administrator defines the organization of this database 131 by means of its terminal 120.

The users are each characterized by a unique identifier 1311, determined or calculated by the module 131 at his/her first registration. They are also characterized by a status, for example:
tournament manager,
player,
team leader,
table football apparatus owner,
referee,
advertiser,
sponsor,
spectator,
visitor.

The table football apparatuses are each characterized by a unique identifier 1312.

The games are each characterized by a unique identifier 1313.

A position 1314 establishes and stores a link between a user identifier 1311 and a game 1313. This link can take 2 or 4 possible values, i.e. either a color (red jersey or blue jersey), either the combination of a place and of a color (red forward, red back, blue forward, blue back).

### Website 132

The website management module 132 contains software applications able to:
develop applications and interfaces intended for users (171, 173) and administrator (121,122),
manage the interaction between these interfaces and the server 130 via the communications module 137,
manage the download of these applications 171 and 121,
manage the interactions with websites and social networks 150, not shown, such as Facebook® or Twitter®, connected to network 140.

The module for controlling access to the football tables 133 contains software applications able, in interaction with the other modules of server 130, to:
calculate rights of access 1331 each associated with a user identifier 1311,
manage the access rights database 1331,
calculate the individualized access authorizations 1332, each associated with a user identifier 1311,
manage the database of the individualized accesses 1332,
calculate the collective access authorizations 1333, each associated with a game identifier 1313,
manage the database of the collective accesses 1333,
calculate a game request 1334 to be transmitted by server 130 by means of communications modules 137 and 111 to a football table 110 via network 140. This game request 1334 comprises four individualized access authorizations 1332 and one collective access authorization 1333.

### Access Rights 1331

In more detail, a player's access right 1331 typically depends on the following arguments or parameters:
his prior application for registration to a tournament,
the acceptation of this application by a team leader,
the prior constitution of a duo,
the prior reservation of a football table at a set time, corresponding to a planned game 1313,
the payment of a subscription,
the absence of ban from refereeing.

The individualized access authorization 1332 characterizes an individualized game profile including in particular the following possibilities:
the force feedback in the rods of the football table is more difficult for a player having received by refereeing a penalty,
the possibility to transmit messages to or to receive messages from spectators depends on the subscription level or on the player's rating,
more generally, the access to a set of services by a player on his smartphone 170 during the game 1313 by means of application software 171.

### Individualized Access Authorization 1332

The individualized access authorization 1332 typically depends on the following arguments:
the access right 1331,
the reception by the server 130 of four access requests 1711 corresponding to a prior reservation for a planned game 1313, the rating of each player,
the penalties given by refereeing in the course of the game.

The collective access authorization 1333 characterizes a game profile of a game 1313 and allows in particular controlling:
the serving of the balls of the table football 110,
the insertion of advertisements before serving a ball, with more or less long duration of the advertising announcement depending on the subscription of the players registered for a game 1313,
the force feedback in the rods of the football table with, for example, a stronger feedback as the tournament progresses,
the animation times (video, music, projector, messages exchanged with spectators) that are preferably longer and longer as the tournament progresses.

### Interaction Rights of the Users 134

The module for controlling the interaction rights of the users 134 comprises software applications able to manage these rights for each user depending on several parameters, among which his status. These rights allow each user to interact with the computer system 100 by means of a man/machine interface 173. Examples of interactions depending on the status are described below.

Thus, a tournament manager may:
create a new tournament and enter it into the database 131,
invite team leaders to sign up for a tournament,
characterize a tournament by a set of games 1313,
plan a game 1313 in a calendar,
distribute the duets and solos in a tournament table depending on the rating of the players,
characterize a game 1313 by two or four identifiers of players grouped in two duets or two solos,
assign a player to a position 1314 in a game 1313,
characterize a game 1313 by a table football identifier 1312, advertisers, sponsors,
create trophies (medals, cups, subsidized subscriptions),
define the rules of attribution of these trophies to the players, duets or teams.

Furthermore, a player may:
create his profile by indicating his name and address,
declare his rating in different table football federations,
apply for a registration in a tournament or in a team,
invite another player to form a duet; a duet is characterized by an own name and rating,
buy or freely get a subscription.

A player can also access a set of services accessible by application software 171 of his terminal 170 depending on his individualized access authorizations 1332:
invite other players to form a relational network of friends within the database 131,
invite friends on a social network 150 such as Facebook®, via network 140, to join this relational network,
challenge another player,
organize an friendly game, invite other players, get information on the football tables nearby and reserve an available football table,
access a football table for playing,
display the score of the game in progress, in which he participates, display refereeing information, the game rules, information on the organization of the tournament, on other players,
display statistics about the game, the players and the playing figures (skill rate, kicking power, generated energy),
display the players' biometric statistics: pressure onto the handles, electrical conductivity, heart rate as well as derived calculations (stress, nervousness, concentration),
display the players ranking according to their rating,
receive messages from spectators, personalized animations (music, video, replay),
receive virtual presents or trophies,
view a game event log, a virtual replay of the game, a calculation of ball trajectory or a photo gallery of the game,
view or record a replay, i.e. the last seconds of a particular action such as a goal. Furthermore, this enables the players to examine the points of shooting, the angles used as well as the placement of the playing figures on the ball at the time of shooting, by means of the display of these data by video inlaying,
obtain personalized playing advice.

A team leader can:
create a team (a team is characterized by an own name and rating),
invite players to constitute this team,
accept the application for registration of a player in a team or in a tournament, register a team for a tournament.

An owner or a lessee of a table football apparatus may:
register a new football table into the database 131; a football table is characterized by its identifier 1312, its brand, its options, the list of its sensors 112 and actuators 113 and its address,
define a calendar of availabilities for his football tables,
provide information relating to the reception of the players or spectators on site (parking spaces, catering, photo gallery).

A referee may:
correct the decisions of the electronic refereeing, among which the score of a game or a player's rating.

An advertiser may:
enter an advertisement and the distribution rules of this advertisement into the database 131,
design scenarios for the animation of a game that are edited by the actuator control module 135, allowing him to animate the games by means of the multiple actuators 113 and screens 172 depending on the evolution of the score, the players' profiles, the biometric sensors 112 or the geolocation of the football table,
provide information relating to his merchandising products (balls, T-shirts, personalized football table, advertising signage).

A sponsor may:
enter subsidized subscriptions and coupons into the database 131 and the allocation rules for these subsidized subscriptions.

A spectator may:
register to attend a game in person or on-line,
send messages or tweets, use the social network tools.

A visitor may:
download an application software 171 on his terminal 170 from the server 130 or from a specialized application server such as Apple App Store® or Amazon App Store®,
register himself into the database 131 by means of application software 171.

When registering for the first time, a user identifier value 1311 is calculated and entered into the database 131, and copied into the user identifier memory 1713 of the smartphone 170,
define his status (player, spectator, sponsor, advertiser, referee).

Control of the Actuators 135 of the Football Table

The actuator control module 135 contains software applications that allow:
reading the access authorizations 1332 and 1333 in module 133.
reading the values of sensors 112 via the communications modules 111 and 137,
developing and edit automatic actions from the administrator terminal 120; these automatic actions control the actuators 113 depending on the access authorizations 1332 and 1333 and on the values of sensors 112,
developing and editing animation scenarios from the advertiser user terminal; with these scenarios, it can be defined, for example, which type of advertisement is played when a goal is scored or at the end of the game,
individually controlling each actuator 113 via the communications modules 111 and 137.

The refereeing module 136 contains software applications that allow in particular:
reading the values of the sensors 112 via the communications modules 111 and 137, in real-time or quasi-real-time,
calculating the score, the refereeing information (goal, fall, spin move, midfield), the penalties for each game 1313,
transmitting this information to the actuator control module 135 for displaying and to the access control module 133 for updating the access rights 1331,
outputting the rules to have them modified by the administrator terminal 120,
calculating the initial rating of each player at the time of his registration depending on his declaration and/or by reading his rating in servers 160, not shown, of other table football federations,
calculating the rate of each player depending on the score of the games 1313 in which he has played as well as the ratings of his teammates and opponents.

The communications module 137 contains software applications that allow the server 130 to exchange information with the football tables 110 and the terminals 120 and 170 via network 140. This module 137 further contains time-stamping means for a request transmitted to the server 130 via network 140.

The computer network 140 is a network such as the Internet.

Smartphone 170

The user terminal or smartphone 170 is a computer system such as a PC, a smartphone or a tablet. This terminal 170 is preferably equipped with a screen 172 and with a touch pad 174 or a keyboard allowing to the user to interact with the computer system 100 by means of application software 171. This terminal 170 is further equipped with communications means 176 adapted to connect the terminal to a computer server 130 via a network 140 or directly to a football table by means of a connection 117 such as a Wi-Fi, a Bluetooth or a wired connection on one of the ports of terminal 170. This terminal 170 is also advantageously equipped with a camera 175.

Application Software 171

The application software 171 can calculate a request for access 1711 to a football table on the basis of the following elements:
image-capture means for recording the image of a QR-code 115 by means of a camera 175,
means for extraction of an identifier 1312 of a football table 110 from this image of a QR-code 115,
means for recording a user identifier 1713 by copying the value of the user identifier 1311 of the database 131 when first registering the user in the database 131,
means for calculating a request for access 1711 to a football table using this football table identifier 1312 and this user identifier 1713 as arguments.

This application software 171 further comprises means allowing a user to assign a value to a playing position declaration 1714, in particular:
means for diagrammatic representation on interface 173 of a football table as seen from above on which four areas are superimposed: forward red 1731, back red 1732, forward blue 1733 and back blue 1734,
means for selecting one particular area among these four areas depending on the value of a playing position identifier 1151,
means for registering a player's name in each of these areas,
means allowing a user, be means of the touch pad 174, to drag with his finger the player's name to another area,
means for checking of the compatibility of this change with predefined conditions and for calculating the positioning of the other names of players in the remaining areas,
means allowing to a user to validate and register the declaration of playing position 1714,
means for reading in the database 131.

This application software 171 further allows the calculation of information on playing position individualization 1712 on the basis of the following elements:
means for extracting a playing position identifier 1151 from this image of a QR-code 115,
means for calculating information on playing position individualization 1712 with a declaration of playing position 1714 and/or at least one playing position identifier 1151 and a user identifier 1713 as arguments.

Moreover, this application software 171 allows providing a set of services 1715 available to the user depending on his individualized access authorizations 1332 that allow him to interact with the computer system 100 as detailed above.

Method for Access Control 200

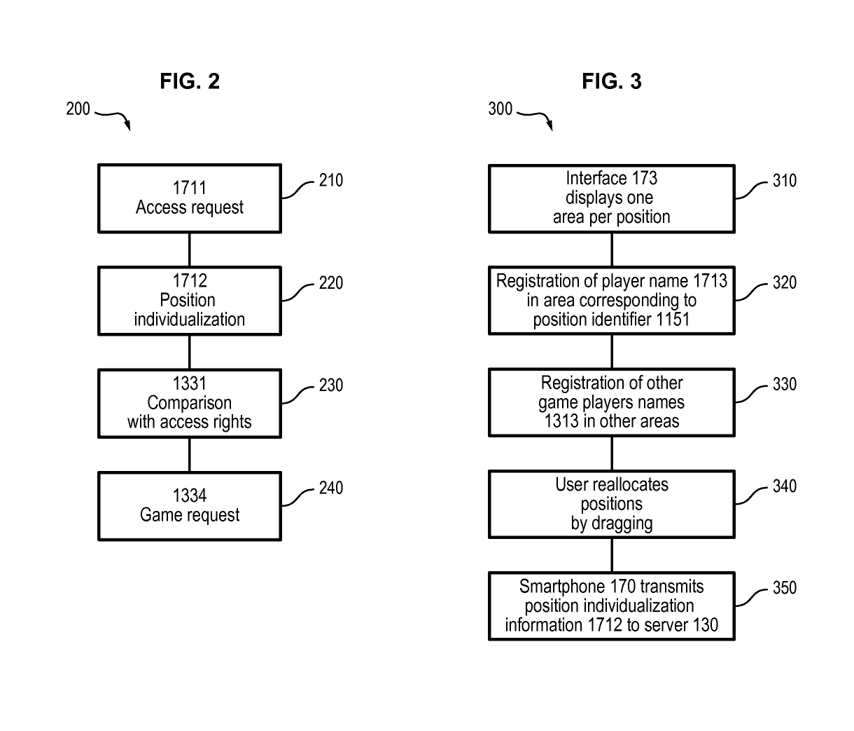

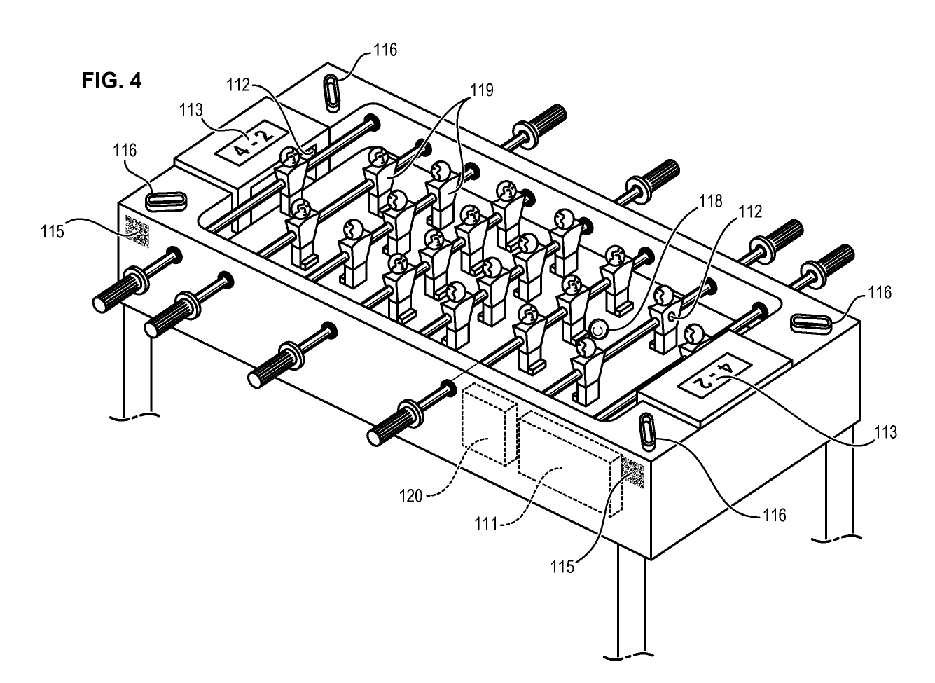

Referring to FIG. 2, a method 200 for control of simultaneous access with an individualized use to a table football apparatus implementing the service 110 of the invention is implemented by a computer system 100 associated with the table football apparatus 110 that is equipped with sensors 112, a server 130 and at least one terminal 170 which can communicate with this server 130, and comprises the following steps:
step 210: reception by server 130 of at least one access request 1711 from the smartphones 170 of at least one user, each having an identifier 1312 associated with a football table 110 and an identifier 1713 associated with a user as arguments,
step 220: reception by server 130 of at least one information on playing position individualization 1712 from at least one smartphone 170,
step 230: comparison by server 130 of the access requests 1711 and individualization information 1712 with the access rights 1331,
step 240: transmission of a game request 1334 by server 130 to the football table 110 and to the four smartphones 170.

These different steps are detailed below.

Step 210: Access Request from the Smartphones to the Server

Step 210 is detailed according to the following sub-steps:
step 211: each of the four players is provided with a smartphone 170; by means of the camera 175, each of them records the image of one of the four QR-codes 115 placed on the football table 110,
step 212: the application software 171 of each of the four smartphones 170 extracts the football table identifier 1312 from each image of QR-code 115,
step 213: the application software 171 of each of the four smartphones 170 calculates a request for access to the football table 1711 with this football table identifier 1312 and the previously entered user identifier 1713 as arguments,
step 214: each of the four smartphones 170 transmits this request for access to the football table 1711 to the server 130 via network 140 and communications modules 176 and 137,
step 215: reception of this request 1711 by server 130 and time stamping by module 137.

Step 220: Individualization of the Playing Positions

Step 220 is detailed according to the following sub-steps:
step 221: the application software 171 of each of the four smartphones 170 extracts the playing position identifier 1151 from each image of QR-code 115,
step 222: the application software 171 of each of the four smartphones 170 calculates information on playing position individualization 1712 with this playing position identifier 1151 and the previously entered user identifier 1713 as arguments
step 223: each of the four smartphones 170 transmits this playing position individualization information 1712 to the server 130 via network 140 and communications module 176,
step 224: reception of this playing position individualization information 1712 by the server 130 via communications module 137.

Step 230: Verification of the Access Rights

Step 230 is detailed according to the following sub-steps:
step 231: the server 130 transmits the four requests for access to the football table 1711 to the access control module 133, each request having the identifier of this football table 1312 and the user identifier 1713 as arguments,
step 232: the access control module 133 verifies in the database 131 that there does exist a game 1313 planned by the tournament manager and that corresponds to the football table identifier 1312 and to the time stamping of the requests 1711 by module 137,
step 233: the access control module 133 checks in the database 131 that the four players' identifiers 1311 associated with this game 1313 correspond to the four user identifiers 1713,
step 234: the server 130 transmits to the access control module 133 the four pieces of information on playing position individualization 1712, each of them together with the playing position identifier 1151 and the user identifier 1713,
step 235: the access control module 133 verifies in the database 131 that the combination of playing position identifiers 1151 and user identifiers 1713 corresponds to the combination of playing position identifiers 1314 and user identifiers 1311 associated with this game 1313,
step 236: the access control module 133 calculates the access rights 1331 of each of these users 1311 depending on the verifications made at steps 232, 233 and 235,
step 237: the access control module 133 compares the requests 1711 and the individualization information 1712 with the access rights 1331.

Step 240: Access Authorization by Server

Step 240 is detailed according to the following sub-steps:
step 241: the access control module 133 calculates four individualized access authorizations 1332 corresponding to these user identifiers 1311,
step 242: the access control module 133 calculates a game request 1334,
step 243: by means of the communications module 137, the server 130 transmits this game request 1334 to the football table 110 and to the smartphones 170 via network 140.

Method 300: Declaration of the Playing Positions by the User

Referring to FIG. 3, the method for playing position declaration 300, implemented by a computer system 100 comprising a table football apparatus 110 equipped with QR-codes, a server 130 and at least one terminal 170 capable of communicating with this server 130 is an alternative to step 220. If, in step 211, only one of the four users captured his QR-code 115, the steps 212 and following are consequently carried out by one single smartphone. This method 300 comprises the following steps:
step 310: the application software 171 displays on interface 173 the diagrammatic representation of one area per playing position,
step 320: the application software 171 writes the player's name 1713 in the area corresponding to the playing position identifier 1151,
step 330: the application software 171 writes the name of the other players in the remaining areas depending on the data relating to game 1313,
step 340: by means of touch pad 174, the user can reallocate the playing positions by dragging the names of the players to other areas,
step 350: the smartphone 170 transmits information on playing position individualization 1712 to the server 130.

Step 310 is detailed according to the following sub-steps:
step 311: the application software 171 displays on interface 173 the diagrammatic representation of a football table as seen from above,
step 312: the application software 171 displays on the interface 173, superimposed with this diagrammatic representation, four areas i.e. forward red 1731, back red 1732, forward blue 1733 and back blue 1734.

Step 320 is detailed according to the following sub-steps:
step 321: the application software 171 of the smartphone 170 extracts the playing position identifier 1151 from the image of the captured QR-code 115,
step 322: the application software 171 selects a first particular area corresponding to the value of the playing position identifier 1151,
step 323: by means of communications modules 176 and 137, the application software 171 reads the name of the player associated with the value of the user identifier 1713 in database 131,
step 324: the application software 171 writes this player name associated with the value of the user identifier 1713 in this first area.

Step 330 is detailed according to the following sub-steps:
step 331: the application software 171 reads in database 131 the identifier of the planned game 1313 corresponding to the identifier of the football table 1312 identified in step 212 and to the time stamping of the request 1711 marked by module 137,
step 332: the application software 171 reads in database 131 the name of the player teaming up as a duo with player 1713 in this game 1313,
step 333: the application software 171 writes the name of this player teaming up as a duo with the player 1713 in a second area of the same team color as this first area,
step 334: the application software 171 reads in database 131 the name of the two opponents in this game 1313,
step 335: the application software 171 randomly writes the names of these two opponents in the two remaining areas.

Step 340 is detailed according to the following sub-steps:
step 341: if the user drags by means of the touch pad 174 one of the four names to another area, the application software 171 updates the registration of the name of the team mate and of the two opponents' names according to the following rules:
a drag from area 1731 to 1732 causes the exchange of the playing positions (forward, back) of the two red teammates,
a drag from area 1731 to 1733 causes jersey permutation (red or blue) of the two teams without changing places,
a drag from area 1731 to 1734 causes both jersey permutation of the two teams and exchange of the places of the two teammates who became blue,
the other rules are set out by symmetry of the three rules above.
step 342: the application software 171 checks in the database 131 and the refereeing module 136 if the dragging is compatible with the organization of the tournament and with the refereeing rules,
step 343: the user validates the declaration of playing position 1714.

Step 350 is detailed according to the following sub-steps:
step 351: the application software 171 calculates playing position individualization information 172 with the declaration of playing position 1714 and the user identifier 1713 as arguments,
step 352: by means of communications modules 176 and 137, the smartphone 170 transmits this playing position individualization information 1712 to server 130.

### Extensions

Many other embodiments or alternatives of this invention are possible.

In particular, when in step 211 two terminals of opponent players captured and decoded their respective QR-codes, the application software 171 selects in step 322 two first particular areas corresponding to the two playing position identifiers 1511. The application reads in step 323 the names of the two corresponding players in the database 131 and writes them in these two first areas in step 305. The method will be adapted similarly if the two users are teammates or if three players captured their QR-code. In this way, the method allows an individualized identification of players by keeping flexibility between the number of captured QR-codes and the additional playing position declarations made by the players.

Moreover, for economical reasons, the number of different QR-codes printed on the football tables may be reduced. It may in fact be interesting to produce a series of ten absolutely identical football tables, including their QR-codes. Then the application software 171 cooperates with the geolocation module of the smartphone, not shown, to calculate a request 1711 having the geolocation coordinates as additional argument. The database 131 can then establish the list of the football tables corresponding to the received QR-code. The database 31 then compares these geolocation coordinates with the addresses of these listed football tables. The address corresponding to these geolocation coordinates allows identifying a unique football table 1312. It is even possible to locate the football tables or other pieces of equipment only by geolocation of the smartphones of participant users which have been involved in the identification process.

The colors red and blue of the playing figures may be different, including patterns such as stripes. In this case, the table football apparatuses are advantageously characterized in the database 131 by additional parameters associated with these colors. The color of their diagrammatic representation on interface 173 is calculated accordingly.

The invention can be adapted to different types of physical game apparatuses such as table shuffleboard game, American billiard, table tennis, football field or any other collective sports comprising accredited playing positions. The adaptations are, for example, as follows:
in case of American billiard, a RFID chip is integrated into each ball and a RFID sensor in each hole to identify which ball has fallen into which hole,
in case of a table tennis or ping pong tabletop, each racquet, the table and the net are equipped with shock sensors 112 allowing server 130 to calculate the points by applying rules 136; for example, if the ball successively hit the bat A, the table half B but not the racquet B within one second, the point is scored for the player A.
in case of a football pitch, 34 QR-codes corresponding to the 22 playing positions and 12 substitutes are printed on a panel fixed in the vicinity of the pitch. During the game, the change of a player by a substitute is declared by a user on his smartphone by dragging the substitute's name to the area corresponding to the playing position at which this player has to play. The ball is equipped with a GPS geolocation radio transmitter. GPS receivers are placed around the pitch, at ground level and at a raised positions to trace the trajectory of the ball in three dimensions.

The invention can also be adapted to the placing of passengers in an airplane, a train or any public transportation with dedicated seats. The participants can thus be players, passengers etc. and the pieces of equipment can be game or sports apparatuses or facilities, public transportation vehicles etc.

The invention can implement different identification mode, in particular:
a protocol of inverted QR-code; in this case, the table football apparatus 110 is equipped with a QR-code reader. When a user wants to play, a QR-code is displayed on his screen 172. The user presents his screen in front of this QR-code reader. The football table 110 transmits an access request to the server 130, which returns to the user's smartphone 170 the list and the playing positions of the players of the game 1313 that is prerecorded in database 131. The application software 171 displays a representation of the football table like in step 302. The application software 171 then writes the names of these players in the areas corresponding to these playing positions for game 1313. The method continues with steps 341 and following.
a NFC protocol implementing four NFC sensors instead of four QR-codes,
a code recognition sensor fixed on a football table, this code being displayed by SMS on a smartphone 170.

The computing resources of the system 100 can be organized differently, for example:
the interaction mode between the application software 171 and the server 130 can operate in push mode; thus, the application software 171 does not read information in the database 131 but conversely the database 131 updates an image database in each smartphone 170 each time one of its data is changed.
the standard software technologies vs. cloud allow shifting the material and software resources onto the terminals vs. the servers. Thus, the application software 121 and 171 can be more or less sophisticated or light in addition to the resources placed in the server 130. Similarly, modules 131, 132, 133, 134, 135 and 136 may be distributed in full or in part in separate servers.

Of course, this invention is in no way limited to the foregoing but the skilled person will be able to make many other changes thereto.

1. A system comprising:
a plurality of pieces of equipment, each of them being able to receive a group of participants, each piece of equipment defining a position for a participant and each piece of equipment being provided with a digital processing unit,
a central server,
network communications means between the central server and the plurality of pieces of equipment,
a plurality of participants' terminals capable of network communications with the central server and of interacting with the processing unit of the piece of equipment,
means for managing sessions on the piece of equipment, implemented by cooperation between the central server and the processing units of the pieces of equipment via the communications means, and
control and identification means implemented by cooperation between the central server, the processing units of the pieces of equipment and the terminals and allowing, on the one hand, the access to sessions on the equipment by a group of participants and their identification and, on the other hand, an allocation of each identified participant to a position at the piece of equipment.

2. A system according to claim 1, wherein the control and identification means comprise means for reading a position(s) code at the equipment among a set of such codes by a participant's terminal, means for communicating from said terminal to the central server a participant's identifier and information representative of the read code.

3. A system according to claim 2 wherein the position codes at the piece of equipment are selected among optical codes and codes readable by near-field communications interrogation.

4. A system according to claim 3, wherein the position codes at the piece of equipment also encode an identifier of a piece of equipment or of a group of pieces of equipment.

5. A system according to claim 2, wherein the control and identification means further comprise means for enabling a functionality of the piece of equipment from the central server when conditions required for the participants and the pieces of equipment and/or their positions have been determined as being fulfilled by the central server.

6. A system according to claim 1, wherein each piece of equipment is identified by the central server by means of a unique identifier associated with the piece of equipment.

7. A system according to claim 1, for fixed pieces of equipment, wherein each piece of equipment is identified by the central server by means of an identifier combined with a geolocation information of the piece of equipment.

8. A system according to claim 4, wherein the geolocation information is obtained from a user's terminal communicating with the central server.

9. A system according to claim 1, further comprising means provided in a participant's terminal and/or at the processing unit of a piece of equipment for modifying, via a communication with the central server, associations between participants and positions stored in said central server.

10. A system according to claim 5, wherein a required condition is a required number of participants.

11. A system according to claim 5, wherein a required condition is an association between each position at the equipment and an identified participant.

12. A system according to claim 1, wherein the piece of equipment is a physical game apparatus.

13. A system according to claim 12, wherein the physical game apparatus comprises a set of sensors for providing information relating to the progress of the game to the central server via the communications means.

14. A system according to claim 12; wherein the physical game apparatus comprises devices capable of being controlled from the central server.

15. A method for managing the use of a piece of equipment by participants, wherein the piece of equipment is capable of implementing sessions involving a group of participants and defines for each participant a position, and wherein the piece of equipment is provided with a digital processing unit and with a set of wireless-readable codes that identify positions at the equipment, the method comprising the following steps:
reading, by terminals associated with a group of participants, a set of wireless-readable codes provided at a same piece of equipment,
transmitting to a central server requests for participation for the considered piece of equipment, said requests containing information representative of the read codes and of the identifiers of the respective participants,
verification at the central server of conditions required for the participants and the position codes,
in case the conditions are fulfilled, transmitting by the central server to the processing unit of the piece of equipment session authorization information,
processing said session authorization information at the processing unit to start a session at the piece of equipment.

16. A method for managing the use of a piece of equipment by participants, wherein the equipment is capable of implementing sessions involving a group of participants and defines a position for each participant and wherein the equipment is provided with a digital processing unit and with a device for reading wireless-readable codes capable of identifying participants to sessions at the equipment, the method comprising the following steps:
reading by the reader of a set of wireless-readable codes associated with a plurality of participants,
transmitting requests for participation for the considered piece of equipment to a central server, said requests containing information representative of the read codes and of positions at the equipment,
verification at the central server of conditions required for the participants and the position codes,
in case the conditions are fulfilled, transmitting by the central server to the processing unit of the piece of equipment session authorization information,
processing said session authorization information at the processing unit to start a session at the piece of equipment.

17. An intelligent terminal for the participation of participants to sessions at a piece of equipment for the implementation of the method according to claim 15, comprising:
means for wireless reading of a position code at a piece of equipment,
network communications means for communicating to a central server for equipment management information representative of the position code and a participant's identifier.

18. An intelligent terminal for the participation of participants to sessions at a piece of equipment for the implementation of the method according to claim 16, comprising:
means for selectively displaying a wireless-readable code identifying a participant owning the terminal.

19. A terminal according to claim 17, further comprising means for communicating with a processing unit of a piece of equipment so that said processing unit can communicate with the central server via the terminal communicating means.

20. Software package capable of being executed on a communicating terminal in order to obtain a terminal according to claim 17.
